(19) United States
(12) Patent Application Publication
(10) Pub. No.: US 2018/0174776 A1
(43) Pub. Date: Jun. 21, 2018

(54) BUTTON ASSEMBLY AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Wen-Jie WANG, Shenzhen (CN); Xin YANG, Shenzhen (CN)

(21) Appl. No.: 15/413,401

(22) Filed: Jan. 23, 2017

(30) Foreign Application Priority Data
Dec. 16, 2016 (CN) 201611165753.3

(51) Int. Cl. H01H 13/14; H01H 13/52

(52) U.S. Cl. CPC H01H 13/14; H01H 13/52

(57) ABSTRACT

A button assembly for an electronic device includes a button and an elastic member. The button includes a cap, and a latch member for latching to the cover. The elastic member includes a first resisting portion, a second resisting portion, and an elastic main portion connecting the first resisting portion to the second resisting portion. A cavity in the elastic main portion allows the cap to be driven to press against the first resisting portion. An electronic device using the button assembly is also provided.

### FIELD

The subject matter herein generally relates to a button structure, and particularly relates to a button assembly for an electronic device.

### BACKGROUND

Assemblies for actuating switch closures in response to a manual movement of a member, such as multifunction button assemblies, have seen increasing utility and are often found in such devices as computer interfaces, joysticks, automotive mirror controls, and the like. One application for multifunction button assemblies is in telecommunication devices such as televisions and associated peripherals (control boxes, remotes, video players, and the like). Multifunction buttons incorporated into these devices allow an user to select responses to menu prompts in a quick and efficient manner, using a minimal amount of user interfaces.

### BRIEF DESCRIPTION OF THE DRAWINGS

Implementations of the present technology will now be described, by way of example only, with reference to the attached figures.

FIG. 1 is an isometric view of an embodiment of an electronic device with a button structure.

FIG. 2 is an isometric view of the button structure shown in FIG. 1.

FIG. 3 is an exploded view of the button structure shown in FIG. 2.

FIG. 4 is an isometric view of a button of the button structure shown in FIG. 3.

FIG. 5 is a cross-sectional view of the button structure, taken along line V-V of FIG. 2, in a first position.

FIG. 6 is similar to FIG. 5 with the button structure shown in a second position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented. The term “comprising” when utilized, means “including, but not necessarily limited to”; it specifically indicates open-ended inclusion or membership in the so-described combination, group, series, and the like.

The present disclosure is described in relation to a button assembly and an electronic device using the button assembly.

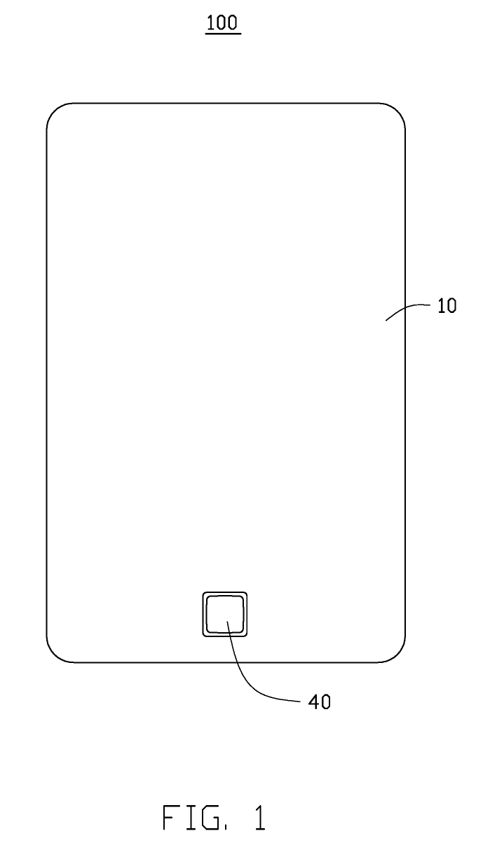

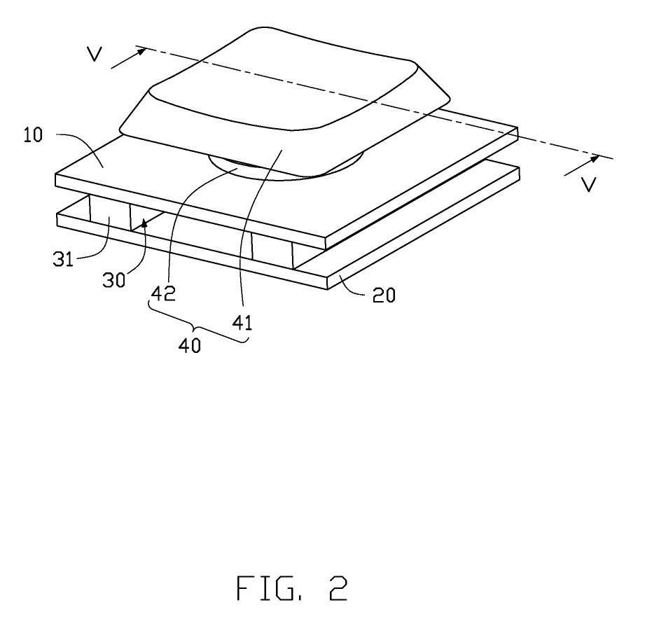

FIG. 1 and FIG. 2 illustrate an electronic device 100 which includes a cover 10, a circuit board 20, a support assembly 30, and a button assembly 40. The circuit board 20 and the support assembly 30 can be received in the cover 10. The support assembly 30 can be sandwiched between the cover 10 and the circuit board 20, forming a gap between the cover 10 and the circuit board 20. The cover 10 can define an assembly hole 11, and the assembly hole 11 can be substantially circular. The button assembly 40 can be mounted in the assembly hole 11, and can abut the circuit board 20, to control the circuits of the circuit board 20.

In this embodiment, the electronic device 100 can further include a battery (not shown), and a storage chip (not shown) together with other components. The battery and the storage chip can be received in the cover 10 to supply electric power and store information.

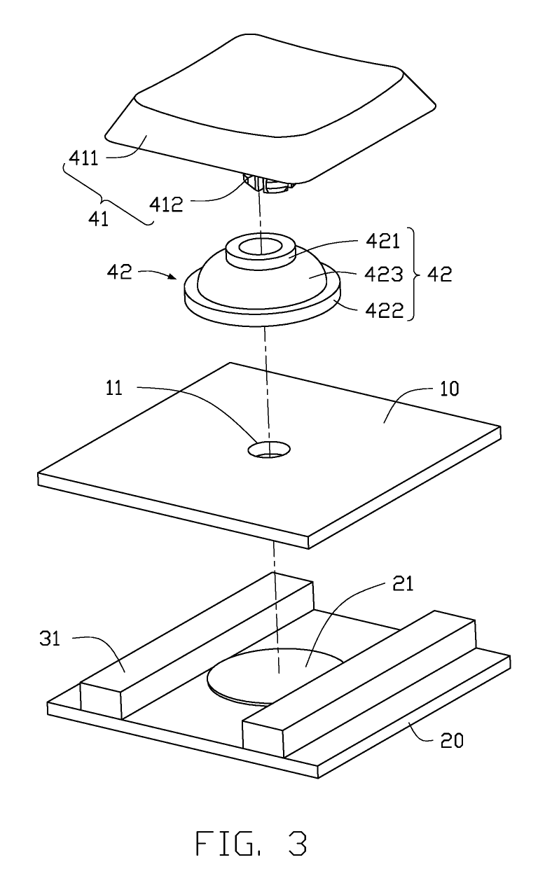

FIG. 3 illustrates that the circuit board 20 can include a contact chip 21. The contact chip 21 can correspond to the assembly hole 11. The contact chip 21 can be compressed by the button assembly 40 to connect or disconnect the button assembly 40 from the circuits of the circuit board 20. In this embodiment, the circuit board 20 can be a printed circuit board.

The support assembly 30 can include a pair of supporting blocks 31 positioned at two sides of the contact chip 21. The pair of supporting blocks 31 can be substantially parallel to each other. Each supporting block 31 can be higher than the contact chip 21, thus a gap is formed between the contact chip 21 and the cover 10 for movements of the button assembly 40.

The button assembly 40 can include a button 41 and an elastic member 42. The button 41 can partially pass through the elastic member 42 and can be movably mounted to the assembly hole 11 of the cover 10. The elastic member 42 can be sandwiched between the button 41 and the cover 10 and abut the underside of the button 41. The button 41 can include a cap 411 and a latch member 412. In this embodiment, the cap 411 can be substantially rectangular, and the latch member 412 can be connected to a center portion of the cap 411.

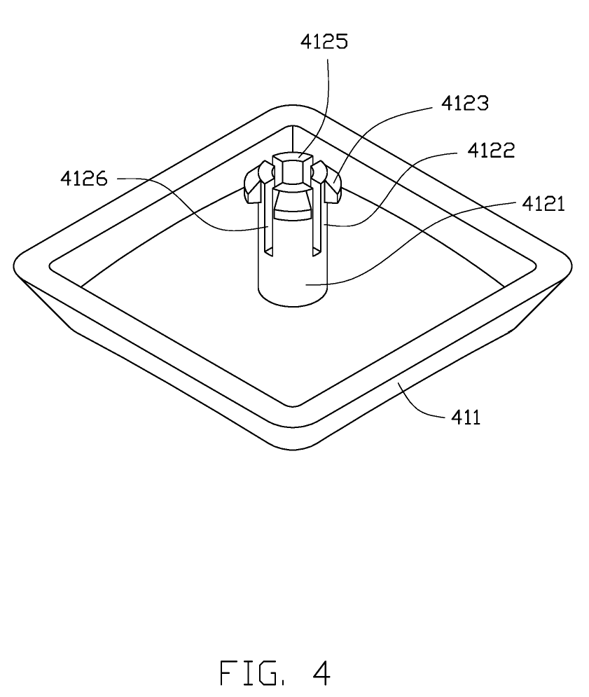

FIG. 4 illustrates that the latch member 412 can include a fastening portion 4121, four elastic arms 4122, and four clasps 4123. The fastening portion 4121 can be substantially a hollow cylinder. One end of the fastening portion 4121 can be mounted to a surface of cap 411 facing the cover 10, and the other end of the fastening portion 4121 can be connected to the four elastic arms 4122. The four elastic arms 4122 can movably pass through the assembly hole 11. A pressing portion 4125 can be formed on an end of each elastic arm 4122 away from the fastening portion 4121 and can be configured to abut the contact chip 21 of the circuit board 20. The four elastic arms 4122 can be parallel to each other. A slot 4126 can be formed between two elastic arms 4122. The slot 4126 can provide a receiving space for the four elastic arms 4122 when the four elastic arms 4122 are compressed. The four clasps 4123 can be respectively mounted to the four elastic arms 4122. Each clasp 4123 can be connected to an end of an elastic arm 4122 away from the fastening portion 4121, and can extend about the elastic arm 4122. The four clasps 4123 can be latched to a surface of the cover 10 facing the circuit board 20 to prevent the button 41 escaping from the assembly hole 11.

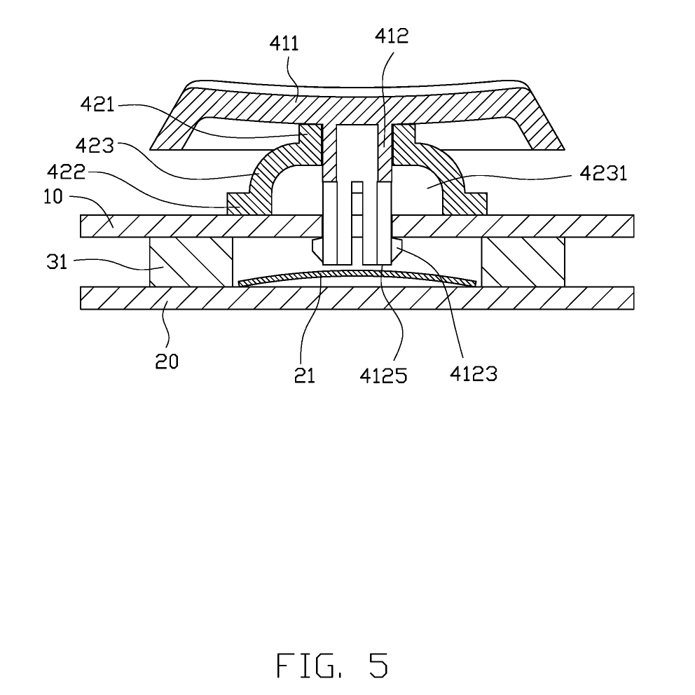

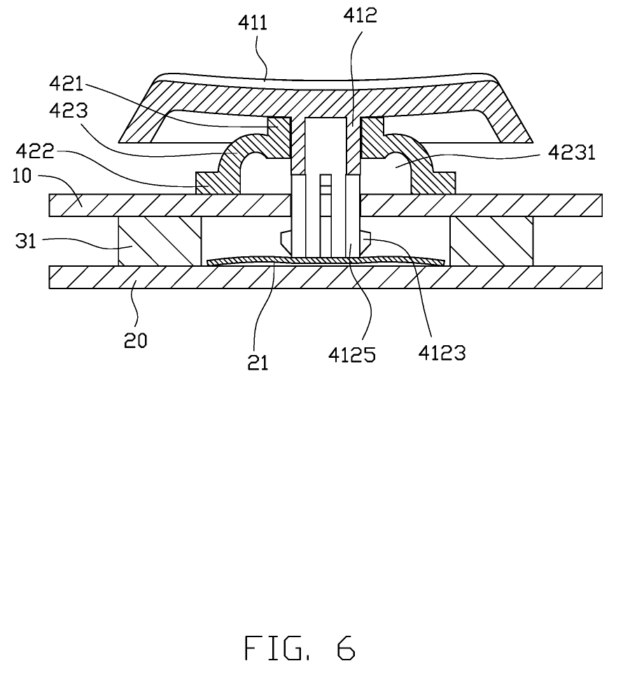

As shown in FIG. 3, FIG. 5, and FIG. 6, the elastic member 42 can include a first resisting portion 421, a second resisting portion 422, and an elastic main portion 423. The first resisting portion 421 and the second resisting portion 422 can respectively abut the cap 411 and the cover 10. The elastic main portion 423 can connect the first resisting portion 421 to the second resisting portion 422.

In this embodiment, the first resisting portion 421 and the second resisting portion 422 can be substantially annular. An inner diameter of the second resisting portion 422 can be greater than an outer diameter of the first resisting portion 421. The fastening portion 4121 of the latch member 412 can pass through the first resisting portion 421. The elastic main portion 423 can be substantially a hollow hemisphere, and a cavity 4231 can be formed in the elastic main portion 423. The cap 411 can be driven to press against the first resisting portion 421, and the elastic main portion 423 can be elastically deformed. The first resisting portion 421 can be pressed toward the cavity 4231 through the elastic main portion 423. The cap 411 can be retracted from the cover 10 through the spring tension of the elastic main portion 423.

In this embodiment, the elastic member 42 can be made of thermoplastic polyurethanes (TPU) to increase the tensile strength of the elastic member 42. In other embodiments, the elastic member 42 can also be made of other resilient polymer materials.

In assembly, the latch member 412 can pass through the elastic member 42, and the four clasps 4123 can extend away from the elastic member 42. The four clasps 4123 can be aligned with the assembly hole 11 of the cover 10. The cap 411 can be pressed toward the circuit board 20 by a user, and the four clasps 4123 can latch to the surface of the cover 10 and face the circuit board 20.

The user can press the cap 411 toward the circuit board 20, and the four elastic arms 4122 of the latch member 412 are urged to move toward the circuit board 20. Each pressing portion 4125 can abut the contact chip 21 of the circuit board 20, to control the circuits of the circuit board 20. When the cap 411 is released by the user, the cap 411 can be moved away from the cover 10 by the spring tension of the elastic member 42. Each pressing portion 4125 can be moved away from the contact chip 21 of the circuit board 20.

In other embodiments, the number of the elastic arms 4122 and the clasps 4123 can be two, three, or more than four. The cap 411 can be substantially circular, triangular, or have other shapes.

In other embodiments, the first resisting portion 421 and the second resisting portion 422 can be omitted and two ends of the elastic main portion 423 can abut the cap 411 and the cover 10.

In other embodiments, the elastic main portion 423 can be substantially tapered, or cylindrical. The elastic main portion 423 can further include a plurality of deformed units (not shown). The plurality of deformed units can connect the first resisting portion 421 and the second resisting portion 422. Each of the plurality of deformed units can be elastically deformed, and the cap 411 can be retracted from the cover 10 through the spring tension of the plurality of deformed units.

In other embodiments, the support assembly 30 can only include a supporting member (not shown). The supporting member can be substantially annular, and can be placed around the contact chip 21 of the circuit board 20.

In other embodiments, the button 41 can be integrally formed from plastic, and the elastic member 42 can be integrally formed from polymer material.

In other embodiments, the latch member 412 can be interchangeable with a hook (not shown). The hook can be latched to the cover 10, and can abut the contact chip 21 of the circuit board 20.

As the button assembly 40 is made up of the button 41 and the elastic member 42, the button assembly 40 has a minimum number of components, thus simplifying the assembly, facilitating manufacturing efficiency, and minimizing material cost.

The embodiments shown and described above are only examples. Many details are often found in the art such as the other features of a button assembly and an electronic device using the button assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A button assembly assembled in a cover of an electronic device, comprising:
a button comprising:
a cap; and
a latch member connected to the cap;
an elastic member sandwiched between the button and the cover, the elastic member comprising
a first resisting portion abutting the cap,
a second resisting portion abutting the cover, and
an elastic main portion connecting the first resisting portion to the second resisting portion;
wherein a cavity is defined in the elastic main portion, the cap is driven to press against the first resisting portion, the elastic main portion is elastically deformed, and the first resisting portion is pressed toward the cavity through the elastic main portion;
wherein the latch member comprises a fastening portion, four elastic arms, and four clasps; wherein one end of the fastening portion is mounted to the cap facing the cover and the other end is connected to the four elastic arms; wherein each clasp is connected to an end of an elastic arm away from the fastening portion to be latched to the cover; wherein a pressing portion is defined on an end of each elastic arm away from the fastening portion and the pressing portion is configured to abut a contact chip of the electronic device.

2. The button assembly of claim 1, wherein the first resisting portion and the second resisting portion are annular, and an inner diameter of the second resisting portion is greater than an outer diameter of the first resisting portion.

3. (canceled)

4. (canceled)

5. The button assembly of claim 1, wherein a slot is defined between every two elastic arms.

6. The button assembly of claim 1, wherein the four elastic arms are parallel to each other.

7. The button assembly of claim 1, wherein the fastening portion passes through the first resisting portion.

8. The button assembly of claim 1, wherein the elastic member is made of thermoplastic polyurethanes.

9. An electronic device comprising:
a cover defining an assembly hole;
a circuit board received in the cover;
a support assembly received in the cover and sandwiched between the cover and the circuit board; and
a button assembly mounted in the assembly hole, comprising:
a button comprising a cap, and a latch member connected to the cap and latched to the cover; and
an elastic member sandwiched between the button and the cover, comprising a first resisting portion abutting the cap, a second resisting portion abutting the cover, and an elastic main portion connecting the first resisting portion to the second resisting portion;
wherein a cavity is defined in the elastic main portion, the cap is driven to press against the first resisting portion, the elastic main portion is elastically deformed, and the first resisting portion is pressed toward the cavity through the elastic main portion.

10. The electronic device of claim 9, wherein the circuit board comprises a contact chip corresponding to the assembly hole and the contact chip is compressed by the button assembly.

11. The electronic device of claim 10, wherein the support assembly comprises a pair of supporting blocks positioned at two sides of the contact chip; wherein the contact chip is on the circuit board; wherein each supporting block has a top surface, and the contact chip has a top surface, the top surface of each supporting block is at a higher position than the top surface of the contact chip.

12. The electronic device of claim 10, wherein the latch member comprises a fastening portion, four elastic arms, and four clasps; wherein one end of the fastening portion is mounted to the cap facing the cover, and the other end is connected to the four elastic arms; wherein each clasp is connected to an end of an elastic arm away from the fastening portion to be latched to the cover.

13. The electronic device of claim 12, wherein a pressing portion is defined on an end of each elastic arm away from the fastening portion and the pressing portion is configured to abut the contact chip of the circuit board.

14. The electronic device of claim 12, wherein a slot is defined between every two elastic arms.

15. The electronic device of claim 12, wherein the four elastic arms are parallel to each other.

16. The electronic device of claim 12, wherein the fastening portion passes through the first resisting portion.

17. The electronic device of claim 9, wherein the elastic member is made of thermoplastic polyurethanes.
